(19) United States
(12) Patent Application Publication
(10) Pub. No.: US 2016/0170473 A1
(43) Pub. Date: Jun. 16, 2016

(54) CONTROL CIRCUIT FOR CONTROLLING POWER OF USB

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XIN YE, Wuhan (CN); CHUN-SHENG CHEN, New Taipei (TW)

(21) Appl. No.: 14/609,716

(22) Filed: Jan. 30, 2015

(30) Foreign Application Priority Data
Dec. 11, 2014 (CN) 201410755602.8

(51) Int. Cl. G06F 1/32; G06F 13/40; G06F 13/42

(52) U.S. Cl. CPC G06F 1/3287; G06F 13/4282; G06F 13/4022; G06F 1/3253

(57) ABSTRACT

A control circuit for controlling a power of USB employed in an electronic device includes a switch unit, a USB interface unit, and a control unit. The switch unit connects to a main board of the electronic device. The USB interface unit includes a power port connected to the switch unit and a ground port. The power port obtains power from the main board and provides the power to the USB interface unit when the switch unit turns on. The control unit connects to the power port and the switch unit. The control unit controls the switch unit to turn on when the power port is at a high level and controls the switch unit to turn off when the power port is at a low level.

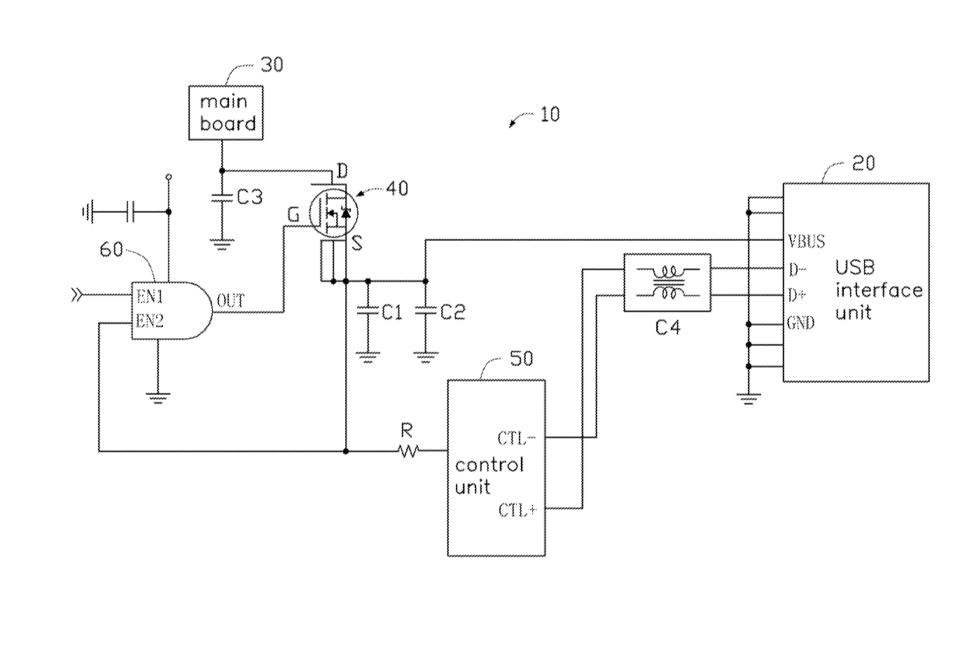

### CROSS-REFERENCE TO RELATED APPLICATIONS

This application claims priority to Chinese Patent Application No. 201410755602.8, filed on Dec. 11, 2014, the contents of which are incorporated by reference herein.

### FIELD

The subject matter herein generally relates to control circuits.

### BACKGROUND

Electronic devices, for example computers, include USB (Universal Serial Bus) interfaces for connecting USB peripheral devices. The USB interface is powered by a main board of the electronic device. When the USB peripheral device shorts out, an electric current of the USB peripheral device may damage the main board.

### BRIEF DESCRIPTION OF THE DRAWING

Implementations of the present technology will now be described, by way of example only, with reference to the attached FIGURE.

The FIGURE is a circuit diagram of a control circuit for controlling a power of USB.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

The FIGURE illustrates a control circuit 10 employed in an electronic device and configured to control a power of USB. The control circuit 10 includes a USB interface unit 20, a main board 30, a switch unit 40, and a control unit 50.

The USB interface unit 20 includes a power port VBUS and a ground port GND. The switch unit 40 connects to the main board 30. The power port VBUS connects to the switch unit 40. When the switch unit 40 is turned on, the power port VBUS obtains power from the main board 30 to power the USB interface unit 20. The control unit 50 connects to the power port VBUS and the switch unit 40. The control unit 50 controls the switch unit 40 to turn on according to a high level of the power port VBUS and controls the switch unit 40 to turn off according to a low level of the power port VBUS.

When the power port VBUS connects to the ground port GND, the power port VBUS is in a low level. Thus, the control unit 50 controls the switch unit 40 to turn off according to the low level of the power port VBUS, and the main board 30 disconnects from the power port VBUS to avoid a heavy current of the USB interface unit 20 damaging the main board 30.

In the embodiment, the power port VBUS connects to one end of a first capacitance C1 and a second capacitance C2. The other end of the first capacitance C1 and the second capacitance C2 are grounded. A resistance R connects the power port VBUS with the control unit 50. An end of the main board 30 connected to the switch unit 40 further connects to one end of a third capacitance C3. The other end of the third capacitance C3 is grounded.

The USB interface unit 20 further includes a data input port D+ and a data output port D−. The control unit 50 includes an input control port CTL+ and an output control port CTL−. The input control port CTL+ connects to the data input port D+. The output control port CTL− connects to the data output port D−. When the power port VBUS is at a low level, the control unit 50 further controls the input control port CTL+ to disconnect the data input port D+, and controls the output control port CTL− to disconnect the data output port D−. When the main board 30 disconnects from the power port VBUS, the power port VBUS is in a low level, and the main board 30 no longer provides power to the USB interface unit 20. According to the low level of power port VBUS, the control unit 50 controls the input control port CTL+ to disconnect the data input port D+, and controls the output control port CTL− to disconnect the data output port D−. Thus, a USB device connected to the USB interface unit 20 does not work, protecting data in the USB device. In the embodiment, the control unit 50 is a south bridge chip. A decoupling capacitor connects the input control port CTL+ and the output control port CTL− with the data input port D+ and the data output port D− respectively.

An AND gate unit 60 is connected between the control unit 50 and the switch unit 40. The AND gate unit 60 includes a first input port EN1, a second input port EN2, and an output port OUT. When the electronic device is running, the first input port EN1 receives a high level signal. The second input port EN2 receives the signal from an end of the control unit 50 connected to the power port VBUS. The output port OUT connects to the switch unit 40. The switch unit 40 controls the main board 30 to connect or disconnect the power port VBUS according to the high or low level of the signal of the output port OUT.

In the embodiment, the switch unit 40 is a MOSFET (Metal-Oxide-Semiconductor Field Effect Transistor). A gate terminal of the MOSFET connects to the output port OUT. A drain terminal of the MOSFET connects to the main board 30. A source terminal of the MOSFET connects to the power port VBUS.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A control circuit for controlling a power of USB employed in an electronic device, the control circuit comprising:
a switch unit connected to a main board of the electronic device;
a USB interface unit comprising a power port connected to the switch unit and a ground port, the power port configured to obtain power from the main board and provide the power to the USB interface unit when the switch unit turns on; and
a control unit connected to the power port and the switch unit, the control unit configured to control the switch unit to turn on according to a high level of the power port and control the switch unit to turn off according to a low level of the power port.

2. The control circuit as claimed in claim 1, wherein the USB interface unit further comprises a data input port and a data output port, the control unit comprises an input control port and an output control port, the input control port connects to the data input port, the output control port connects to the data output port, when the power port is in a low level, the control unit controls the input control port to disconnect the data input port, and controls the output control port to disconnect the data output port.

3. The control circuit as claimed in claim 2, wherein the control unit is a south bridge chip.

4. The control circuit as claimed in claim 3, wherein a decoupling capacitor connects the input control port and the output control port with the data input port and the data output port.

5. The control circuit as claimed in claim 1, wherein an AND gate unit is connected between the control unit and the switch unit, the AND gate unit comprises a first input port, a second input port and an output port, the first input port receives a high level signal during the electronic device is running, the second input port receives a level signal from an end of the control unit connected to the power port, the output port connects to the switch unit.

6. The control circuit as claimed in claim 5, wherein the switch unit is a MOSFET, a gate terminal of the MOSFET connects to the output port, a drain terminal of the MOSFET connects to the main board, a source terminal of the MOSFET connects to the power port.

7. The control circuit as claimed in claim 6, wherein the power port connects to one end of a first capacitance, a second end of the first capacitance is grounded.

8. The control circuit as claimed in claim 7, wherein the power port further connects to one end of a second capacitance, a second end of the second capacitance is grounded.

9. The control circuit as claimed in claim 1, wherein a resistance is connected power port with the control unit.

10. The control circuit as claimed in claim 1, wherein an end of the main board connected to the switch unit further connects to one end of a capacitance, a second end of the capacitance is grounded.

11. A control circuit for controlling a power of USB employed in an electronic device, the control circuit comprising:
a switch unit connected to a main board of the electronic device;
an USB interface unit comprising a power port connected to the switch unit and a ground port, the USB interface unit being powered by the main board when the switch unit turns on; and
a control unit connected to the power port and the switch unit, the control unit configured to control the switch unit to turn on according to a high level of the power port and control the switch unit to turn off according to a low level of the power port.

12. The control circuit as claimed in claim 11, wherein the USB interface unit further comprises a data input port and a data output port, the control unit comprises an input control port and an output control port, the input control port connects to the data input port, the output control port connects to the data output port, when the power port is in a low level, the control unit controls the input control port to disconnect the data input port, and controls the output control port to disconnect the data output port.

13. The control circuit as claimed in claim 12, wherein the control unit is a south bridge chip.

14. The control circuit as claimed in claim 13, wherein a decoupling capacitor is connected the input control port and the output control port with the data input port and the data output port.

15. The control circuit as claimed in claim 11, wherein an AND gate unit is connected between the control unit and the switch unit, the AND gate unit comprises a first input port, a second input port and an output port, the first input port receives a high level signal during the electronic device is running, the second input port receives a level signal from an end of the control unit connected to the power port, the output port connects to the switch unit.

16. The control circuit as claimed in claim 15, wherein the switch unit is a MOSFET, a gate terminal of the MOSFET connects to the output port, a drain terminal of the MOSFET connects to the main board, a source terminal of the MOSFET connects to the power port.

17. The control circuit as claimed in claim 16, wherein the power port connects to one end of a first capacitance, a second end of the first capacitance is grounded.

18. The control circuit as claimed in claim 17, wherein the power port further connects to one end of a second capacitance, a second end of the second capacitance is grounded.

19. The control circuit as claimed in claim 11, wherein a resistance is connected power port with the control unit.

20. The control circuit as claimed in claim 11, wherein an end of the main board connected to the switch unit further connects to one end of a capacitance, a second end of the capacitance is grounded.
